(19) United States
(12) Patent Application Publication
(10) Pub. No.: US 2026/0093998 A1
(43) Pub. Date: Apr. 2, 2026

(54) METHOD AND SYSTEM FOR IDENTIFYING FEATURE IMPORTANCE IN TIME SERIES TASKS

(71) Applicant: Royal Bank of Canada, Toronto (CA)

(72) Inventors: Melissa Farinaz Mozifian, Vancouver (CA); Edward James Smith, Toronto (CA); Wesley Philippe Chung, Montreal (CA); Ankit Vani, Vancouver (CA); Fuyuan Lyu, Montreal (CA)

(21) Appl. No.: 19/342,023

(22) Filed: Sep. 26, 2025

Related U.S. Application Data
(60) Provisional application No. 63/700,433, filed on Sep. 27, 2024.

(51) Int. Cl. G06N 3/092; G06N 3/0455

(52) U.S. Cl. CPC G06N 3/092; G06N 3/0455

(57) ABSTRACT

Methods, systems, and techniques for for identifying feature importance in time series tasks. A reconstruction model is trained to reconstruct unmasked versions of an input that is a time series of data. Following training of the reconstruction model, a reinforcement learning agent is trained to identify features in the time series of data of relative importance. For both the reconstruction model and the reinforcement learning agent, training is performed based at least in part on losses determined in the latent space.

### CROSS-REFERENCE TO RELATED APPLICATIONS

The present application claims priority to U.S. provisional patent application No. 63/700,433, filed on Sep. 27, 2024, and entitled, “METHOD AND SYSTEM FOR IDENTIFYING FEATURE IMPORTANCE IN TIME SERIES TASKS,” the entirety of which is hereby incorporated by reference herein.

### TECHNICAL FIELD

The present disclosure is directed at methods, systems, and techniques for identifying feature importance in time series tasks.

### BACKGROUND

Deep learning models for time series data have seen remarkable progress, especially in applications such as forecasting, anomaly detection and healthcare analytics. These models excel at capturing complex temporal patterns and intricate long-range dependencies, leading to significant improvements in predictive performance. However, their size and complexity often leads to black-box behavior, making it difficult for practitioners and stakeholders to understand the reasoning behind specific model predictions. In many critical applications, such as medical diagnosis or financial decision-making, it is not enough to simply provide accurate predictions. Rather, there is a growing demand for explainable methods that can provide insights into the decision-making process of these models.

### SUMMARY

According to a first aspect, there is provided a method for training a reconstruction model, the method comprising: respectively reconstructing, using the reconstruction model, reconstructed inputs from masked inputs, wherein each of the masked inputs is a differently masked version of a true input, each of the reconstructed inputs is unmasked, and the true input is a time series of data; encoding, using an encoder network, the reconstructed inputs and the true input into respective latent representations in a latent space; and training the reconstruction model based at least in part on losses determined as differences between the latent representation of the true input and the respective latent representations of the reconstructed inputs.

The method may further comprising determining, using a decoder network, respective classifications from the reconstructed inputs and the true input. The reconstruction model may be further trained based on losses determined as differences between the classification of the true input and the respective classifications of the reconstructed inputs.

The reconstruction model may be further trained based on losses determined as differences between the true input and the respective reconstructed inputs.

The masked inputs may be sequentially indexed and any one of the masked inputs may comprise all masks from any prior indexed ones of the masked inputs and has at least one additional portion thereof masked.

The reconstruction model may be a heteroscedastic model.

According to another aspect, there is provided a method for training a reinforcement learning agent, the method comprising: successively unmasking portions of a masked true input to generate respective masked inputs; reconstructing reconstructed inputs from the masked inputs and from an entirely unmasked version of the true input using the reconstruction model as trained in accordance with the above method, wherein the true input is a time series of data; encoding, using the encoder network, the reconstructed inputs as respective latent representations in the latent space; and training the reinforcement learning agent based at least in part on losses determined as differences between the latent representation of the entirely unmasked version of the true input and the respective latent representations of the reconstructed inputs.

The masked true input may initially be entirely masked.

The unmasking may be performed in accordance with the C51 algorithm, the PPO algorithm, or the DQN algorithm.

According to another aspect, there is provided at least one neural network trained in accordance with the above described methods.

According to another aspect, there is provided a use of a reinforcement learning agent trained in accordance with the above described method to produce an attribution mask highlighting features of a time series of data.

According to another aspect, there is provided a system comprising at least one processing unit configured to perform the above described methods.

According to another aspect, there is provided at least one non-transitory medium having stored thereon computer program code that is executable by at least one processor and that, when executed by the at least one processor, causes the at least one processor to perform above described methods.

According to another aspect, there is provided a method for training a reconstruction model, the method comprising: respectively reconstructing, using the reconstruction model, a plurality of reconstructed inputs from the plurality of masked inputs, wherein each of the masked inputs is a differently masked version of a time series input, and each of the plurality of reconstructed inputs is unmasked version of the time series input in a data domain; encoding, using an encoder network, the time series input and the plurality of reconstructed inputs into respective latent representations in a latent space; and training the reconstruction model based at least in part on a latent-space loss determined from differences between the latent representation of the time series input and the respective latent representations of the reconstructed inputs.

In some embodiments, the method may further comprise generating the plurality of masked inputs from the time series input.

In some embodiments, the method may further comprise determining, using a decoder network, respective classifications from the time series input and the plurality of reconstructed inputs, and training the reconstruction model may further comprise reducing a classification loss.

In some embodiments, the classification loss may be determined from differences between the classification of the time series input and the respective classifications of the reconstructed inputs.

In some embodiments, the classification loss may be determined from differences between prediction probabilities output by the decoder network for the time series input and the prediction probabilities output by the decoder network for the respective reconstructed inputs.

In some embodiments, training the reconstruction model may further comprise reducing an input-domain loss determined from differences between the time series input and the respective reconstructed inputs.

In some embodiments, training the reconstruction model may further comprise reducing an input-domain loss determined from differences between the time series input and the respective reconstructed inputs, and training the reconstruction model may further comprise reducing a combined loss defined as a sum of the latent-space loss, the classification loss, and the input-domain loss respectively weighted according to a plurality of hyperparameters.

In some embodiments, the plurality of masked inputs may be sequentially indexed such that any one of the masked inputs comprises all masks from any prior indexed ones of the masked inputs and has at least one additional portion thereof masked.

In some embodiments, the reconstruction model may be a heteroscedastic model configured to output mean and variance values for features of the time series input.

In some embodiments, generating the plurality of masked inputs may comprise masking features according to a sequential order, a random selection, or a contiguous temporal span.

According to another aspect, there is provided a method for training a reinforcement learning agent, the method comprising: successively unmasking, using the reinforcement learning agent, portions of a masked version of a time series input to generate a plurality of masked inputs; respectively reconstructing, by a reconstruction model, a plurality of reconstructed inputs from the plurality of masked inputs using the reconstruction model having been trained to reduce a latent-space loss determined from differences between a latent representation of the time series input and the latent representations of reconstructed inputs; encoding, using an encoder network, the reconstructed inputs and an unmasked version of the time series input as respective latent representations in a latent space; and training the reinforcement learning agent based at least in part on a reward signal derived from differences in the latent-space loss between a plurality of the latent representations.

In some embodiments, the masked version of the time series input may be initially entirely masked, and the unmasked version of the time series input may be entirely unmasked.

In some embodiments, the unmasking may be performed in accordance with a Categorical 51 (C51) algorithm, a Proximal Policy Optimization (PPO) algorithm, or a Deep Q-Learning (DQN) algorithm.

In some embodiments, the reward signal may be further defined as a normalized improvement in the latent-space loss, the normalization being based on the latent-space loss determined from the masked version of the time series input that is entirely masked.

In some embodiments, the method may further comprise generating an attribution mask for the time series input based on unmasking decisions of the reinforcement learning agent.

In some embodiments, generating the attribution mask may comprise assigning an importance score to each feature of the time series input based on an expected reward distribution produced by the reinforcement learning agent, and applying a threshold to the importance scores to produce a binary mask.

In some embodiments, the attribution mask may be used to generate an explanation output that identifies one or more features of the time series input contributing to a classification decision obtained from the time series input.

In some embodiments, the reconstruction model may be trained by: respectively reconstructing, using the reconstruction model, a plurality of historical reconstructed inputs from the plurality of historical masked inputs, wherein each of the historical masked inputs is a differently masked version of a historical time series input, and each of the plurality of historical reconstructed inputs is an unmasked version of the historical time series input in a data domain; encoding, using the encoder network, the historical time series input and the plurality of historical reconstructed inputs into respective latent representations in the latent space; and training the reconstruction model based at least in part on a historical latent-space loss determined from differences between the latent representation of the historical time series input and the respective latent representations of the historical reconstructed inputs.

In some embodiments, the training of the reinforcement learning agent may be formulated as a Markov Decision Process (MDP) defined by: a state space comprising pairs of a time series input and a binary mask indicating masked and unmasked features; an action space comprising indices of features corresponding to masked positions in the binary mask; and a dynamics model that transitions the binary mask by unmasking a selected feature index according to the action.

In some embodiments, the reward signal may be derived from the differences in the latent-space loss between the latent representation of the unmasked version of the time series input and the latent representations of the reconstructed inputs, or from the differences in the latent-space loss between the latent representations of successive reconstructed inputs obtained from the plurality of masked inputs.

According to another aspect, there is provided a system for processing time series data, the system comprising: a reconstruction model configured to receive a plurality of plurality of masked inputs and reconstruct a plurality of reconstructed inputs from the plurality of masked inputs, wherein each of the masked inputs is a differently masked version of a time series input, and each of the plurality of reconstructed inputs is unmasked version of the time series input in a data domain; an encoder network configured to encode the time series input and the plurality of reconstructed inputs into respective latent representations in a latent space; and at least one processing unit configured to train the reconstruction model based at least in part on a latent-space loss determined from differences between the latent representation of the time series input and the respective latent representations of the reconstructed inputs.

This summary does not necessarily describe the entire scope of all aspects. Other aspects, features and advantages will be apparent to those of ordinary skill in the art upon review of the following description of specific embodiments.

### BRIEF DESCRIPTION OF THE DRAWINGS

In the accompanying drawings, which illustrate one or more example embodiments:

FIG. 1 shows an inference pipeline for a time series model, according to an example embodiment.

FIG. 2 shows a reconstruction framework used to quantify relevant information found in a set of unmasked features, according to an example embodiment.

FIG. 3 shows a reinforcement learning training pipeline highlighting how a reinforcement learning agent selects features for unmasking, according to an example embodiment.

FIG. 4 depicts experimental results in relation to epilepsy, according to an example embodiment.

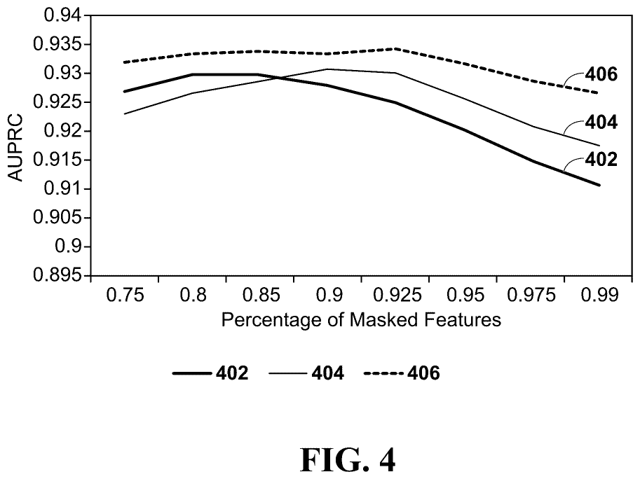

FIG. 5 depicts occlusion experiment results on real-world datasets, according to an example embodiment.

FIG. 6 is an example computer system on which an example method for identifying feature importance for time series tasks may be implemented.

### DETAILED DESCRIPTION

Attribution-based methods for explainability have gained prominence in recent deep learning models, especially in the time series domain, by learning feature importance through the application of attribution masks. These masks are designed to select certain key features that drive model predictions, effectively identifying which aspects of the input contribute the most to determining model output. However, learning to select these discrete binary masks introduces non-differentiablity, which must be resolved using gradient estimation methods. Prior explainable methods such as TimeX [1] and TimeX++[2] have addressed this problem using the Straight-Through Estimator (“STE”). By allowing gradients to flow through the non-differentiable mask operations during back propagation, STE ensures that attribution masks can be optimized in an End-to-End manner. These methods underscore the effectiveness of mask-based attribution in creating transparent, actionable insights in complex time series models.

While STE has been widely used to handle non-differentiable mask operations, it may not always be the best choice for time series models, particularly when long-range dependencies are involved. STE has the advantage of simplicity and computational efficiency. It enables straightforward back-propagation through binary mask operations, making it appealing for scenarios where fast gradient estimation is necessary. However, one notable drawback is its reliance on biased gradient estimates, which can limit its ability to fully capture complex, non-linear relationships, particularly in time series models where deep networks must account for subtle, long-term interactions between features.

The present disclosure is directed at methods and systems for improving gradient estimation for attribution masks by utilizing reinforcement learning (“RL”), and more particularly in at least some example embodiments the Categorical 51 (“C51”) reinforcement learning algorithm instead of the commonly used STE. RL methods such as the C51 algorithm offer an alternative approach to STE by providing unbiased gradient estimates, which can be beneficial in capturing the nuanced temporal features of time series data. The C51 algorithm, with its distributional approach to Q-learning, allows for a more flexible and gradual learning of masks. This can lead to more accurate feature importance scores and smoother learning dynamics, particularly in cases where time series data exhibit continuous or gradual changes.

At least some embodiments herein leverage a distributional Q-learning agent to sequentially unmask the most important features from a fully masked feature set based on their contribution to the model's understanding. To assess the contribution of partially masked feature subsets, a reconstruction model is pre-trained to recover masked elements, ensuring that when passed through the time series model, the latent embedding is as faithful as possible to the original data. The accuracy of this reconstruction model, given a set of unmasked features, serves as an indicator of those features' collective importance to the model's predictions. Using this accuracy as a reward signal for the C51 agent allows the methods and systems of those embodiments to dynamically learn effective unmasking strategies and produce attribution masks. By framing feature selection as a sequential decision-making process, those embodiments identify relatively informative, and ideally the most informative, features in a dynamic and interpretable way. Compared to STE, which can suffer from biased gradient estimates, those embodiments offer unbiased and smoother gradient estimation, making them more effective at capturing the complex dependencies found in time series data.

An example embodiment is evaluated across a wide variety of real and simulated time series datasets, and compared to a large set of strong baselines. Significant and consistent performance increases are demonstrated relative to the prior state-of-the-art of 0.6% in real world datasets and 14.8% in simulated datasets, as measured in terms of area under recall (“AUR”) curve performance. Various embodiments described herein also generate naturally smooth and interpretable attribution masks, relative to prior methods.

### Problem Formulation

The present disclosure focuses on neural network(s) in the form of time series classification models operating over a time series dataset ( [symbol] , [symbol] )={(xᵢ,yᵢ)|i=1, . . . ,N}, where xᵢ represents the input samples and yᵢ denotes the labels for each sample. Each time series input xᵢ∈ [symbol] ^{T×F} is a matrix where T is the length of the time series and F is the number of features. The corresponding label yᵢ∈{1,2, . . . , C} belongs to one of C possible classes.

A reference time series model ƒ(·) is assumed, which maps an input x∈ [symbol] to a class label, i.e., ƒ(x)∈{1,2, . . . , C}. The only assumptions made about ƒ(·) are that it includes an encoder network E(·) that maps the input x to a latent representation L∈ [symbol] ^{l}, and a decoder network D(·) that maps this latent representation L to the class label C. The latent space L is assumed to be accessible for use in subsequent processing, such as similarity analysis, reconstruction-based learning, or reinforcement learning-based attribution. In various embodiments, the encoder may be implemented as a recurrent neural network (“RNN”), a convolutional neural network (“CNN”), or a transformer-based network, and the decoder may output either hard class assignments or probability distributions across the possible classes.

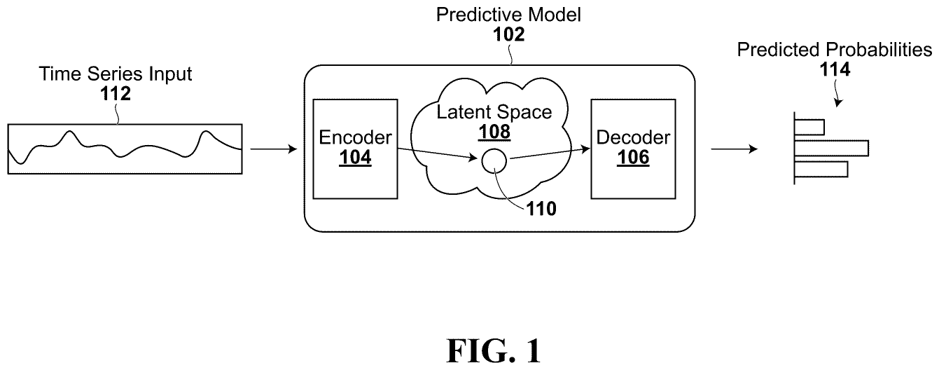

This architecture is depicted in FIG. 1, which shows the inference pipeline for the time series model 102. More particularly, the architecture of FIG. 1 depicts the reference time series model 102 as comprising the encoder network 104 and the decoder network 106. The encoder network 104 receives the input 112 and maps that input 112 to its latent representation 110, which is within the latent space 108. The decoder network 106 uses the latent representation 110 to generate various probabilities 114 respectively corresponding to various classes. The class corresponding to the highest probability 114 is typically the classification decision into which the input 112 is classified. In some embodiments, the attribution mask and associated explanation output may be linked to this classification decision, such that the explanation output explicitly identifies which unmasked features contributed to the predicted class. In some implementations, the latent representation may also be used directly for downstream tasks such as clustering, anomaly detection, or feature importance estimation, thereby enabling broader applicability of the trained model beyond classification.

The present disclosure focuses on the challenge of generating faithful and interpretable explanations for time series models, with a specific focus on attribution masks. For a given time series dataset ( [symbol] , [symbol] ) and pre-trained reference model ƒ(·), an explanation for sample xᵢ is an attribution mask A(·)∈ [symbol] ^{T×F} such that for each input sample of the time series dataset (e.g., a time-sensor pair (j, k), A_{j,k}∈[0,1]), the attribution mask indicates the importance of that feature for the model's prediction, ƒ(xᵢ). Intuitively, a feature's importance indicates on how much it contributed to the model's decision making. In some embodiments, the attribution mask is further processed into an “explanation output” that explicitly identifies which temporal features or sensor channels contributed more to a classification decision generated by the model. In practice, attribution masks and explanation outputs may be used together to highlight salient temporal regions or specific sensor channels, thereby improving transparency in domains such as medical monitoring, financial risk assessment, or industrial process control. Moreover, such attribution masks may be continuous values (e.g., importance scores in [0,1]) or discretized (e.g., binary masks obtained by applying a threshold to the importance scores), and may be employed for tasks such as post-hoc explanation, feature selection, or adaptive sampling of time series signals.

### Methodology

Over a generic time series model, at least some of the example embodiments herein produce attribution masks which highlight the most important features that influence the model's classification decision. This involves performing a discrete decision making process which is non-differentiable. The following describes the framework used to produce the attribution masks, and demonstrates how a combination of deep Reinforcement Learning and Masked Reconstruction is leveraged to optimize over this sampling and extract highly accurate explanations.

### Environment

The mask selection task is formulated as a RL problem by framing it as a Markov Decision Process (“MDP”). A MDP is defined by a 5-tuple (S, A, R, ρ, γ), where S represents the state space, A represents the action space, R is the reward function, ρ is the dynamics model, and γ is the discount factor. The goal is to determine a policy π: S→A, which maps a state s∈S to an action α∈A, in order to maximize the return

$${\sum }_{t = 1}^{∞} {γ}^{t - 1} {r}_{t} ,$$

which represents the discounted sum of rewards obtained by following the policy.

For a given time series input x∈R^{T×d} the state of the MDP at time t is defined as sₜ=(x, m), where m∈{0,1}^{T×d} is a mask with exactly t elements valued 1. In some embodiments, the masking may be applied according to different strategies. For example, features may be masked in a sequential order, by random selection, or over contiguous temporal spans of the time series input such that blocks of adjacent time steps are masked together. An action at time t, αₜ∈[0,1, . . . , T*d−1], is defined as selecting a single zero-valued index from the mask in sₜ. The dynamics model then uses the selected index at αₜ to update the mask in sₜ when transitioning to sₜ₊₁. The reward and policy for the MPD, and how they can be used to define attribution masks, are described below.

### Reward

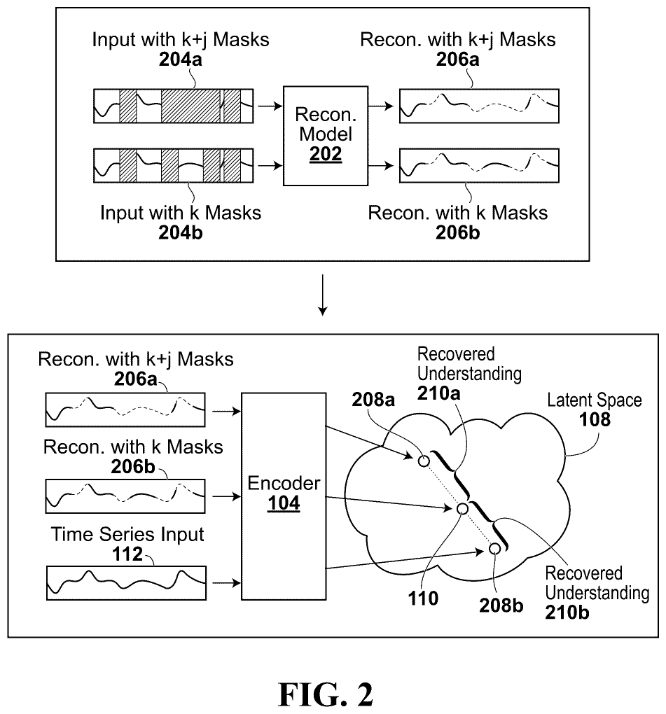

Masked reconstruction techniques are applied to design a reward function for the MDP that encourages the policy to select the most important features. This is depicted in FIG. 2.

First, a reconstruction model 202, R(·) which receives masked inputs 204a,b \hat{x}=M(x, m), where x is the time series input 112 (also referred to as “true input”) and m is a masking vector, and attempts to reconstruct thethe unmasked version of x. The reconstruction model 202 is pretrained prior to reinforcement learning, as highlighted on the left of FIG. 2. More particularly, in the depicted example, first and second masked inputs 204a,b are input to the reconstruction model 202. In this example, the first masked input 204a comprises k+j masks, while the second masked input 204b comprises only k masks; in other words, every portion masked in the second masked input 204b is also masked in the first masked input 204a, and in addition to that, a further portion of the first masked input 204a is also masked relative to the second masked input 204b. The reconstruction model 202 respectively generates first and second reconstructed inputs 206a,b, in which the previously masked portions have been estimated by the reconstruction model 202.

To encourage the reconstruction model 202 to prioritize recovering features that are most relevant to the reference model 102, its parameters are set by reducing (and ideally by minimizing) the Mean Squared Error (“MSE”) in one or more domains.

For example, in the reference model's 102 latent space 108, a latent space loss (Loss_{L}) may be defined as:

$${Loss}_{L} ( x , \hat{x} ) = MSE ( E ( x ) , E ( R ( \hat{x} ) ) ) \qquad ( 1 )$$

where E(·) represents the encoder network 104.

In addition, with the MSE or the Jensen-Shannon divergence (DJs) in the prediction space of the reference model 102, a classification loss (Loss_{C}) may be defined as:

$${Loss}_{C} ( x , \hat{x} ) = MSE ( f ( x ) , f ( R ( \hat{x} ) ) ) \qquad ( 2 )$$

$${Loss}_{C} ( x , \hat{x} ) = {D}_{JS} ( f ( x ) , f ( R ( \hat{x} ) ) ) \qquad ( 2.1 )$$

where ƒ(·) represents the overall reference model (i.e., the composition of the encoder 104 and decoder 106 that maps an input to its predicted class probabilities). In practice, this loss reflects differences at the output of the decoder 106, which corresponds to the prediction space of the model.

Then, in the input space of the reference model 102, an input-domain loss (Lossₓ) may be defined as:

$${Loss}_{X} ( x , \hat{x} ) = MSE ( x , R ( \hat{x} ) ) . \qquad ( 3 )$$

The complete or combined loss (Loss_{R}) of the reconstruction model 202 may then be expressed as a weighted sum of the three losses described above, such as Loss_{R}=λ₁Lossₓ+λ₂Loss_{L}+λ₃Loss_{C}, where λ₁, λ₂ and λ₃ are hyperparameters that respectively weight the contributions of the different domains.

It should be appreciated that MSE is merely one example of a distance metric that may be employed to define the latent-space loss, the classification loss, and/or the input-domain loss. In alternative embodiments, other distance metrics such as cosine similarity, Kullback-Leibler divergence, cross-entropy, or Earth Mover's distance may be employed in place of or in combination with MSE, depending on the characteristics of the input data and the training objective.

Furthermore, the use of all three losses is not required in every embodiment. In some implementations, the reconstruction model 202 is trained based solely on the latent-space loss (Loss_{L}), which quantifies differences between latent representations of the time series input and reconstructed inputs. In other implementations, the training may additionally incorporate the classification loss (Loss_{C}), the input-domain reconstruction loss (Loss_{R}), or both, depending on whether the objective is to emphasize predictive consistency, input-level similarity, or a balance of all three. Thus, the combined loss formulation described above represents one example, and the relative inclusion and weighting of these losses may be varied across embodiments.

In some embodiments, the reconstruction model 202 may be implemented as a heteroscedastic model. Consequently, mean and variance values may be predicted for each feature and sampled from a Gaussian distribution it parameterizes, as opposed to providing a single point estimate of the mean. This approach may be advantageous because point estimates may result in out-of-distribution predictions by converging towards single unrepresentative values in the presence of high noise. By sampling from a parameterized Gaussian distribution, noisy signals that the reference model 202 expects can be predicted, as opposed to only the mean of the noise, which would be out of distribution. In alternative embodiments, other approaches to modeling uncertainty may be used, such as Bayesian neural networks or variational autoencoders.

Once trained to convergence, the reconstruction model 202 can accurately reconstruct the original input 112 and aims to recover the same latent understanding with respect to the reference model 102. The utility of the neural networks collectively used to implement the reconstruction model 202 and the encoder 104 is that their reconstruction error in the latent space 108 under a given masking, Loss_{L}(x, x), can be used to interpret the importance of the set of unmasked features. More particularly, when comparing two masks, mᵢ and mⱼ, if Loss_{L}(x, M(x, mᵢ)) is much lower then Loss_{L}(x, M(x, mⱼ)) then the unmasked features from mᵢ allowed for a much better recovery of latent understanding then those in mⱼ and so are more important to its decision making process in respect of how classification is performed. While this discussion emphasizes classification tasks, the same principle can be applied to regression, anomaly detection, or other tasks where latent fidelity indicates the relative contribution of selected features.

This is shown in FIG. 2. Namely, FIG. 2 shows the reconstruction framework used to quantify the relevant information found in a set of unmasked features. On the left, the trained reconstruction model 202 recovers time series inputs in the form of the first and second reconstructed inputs 206a,b after subsets of features are masked. On the right the importance of the subset of features is quantified based on how much latent understanding is recovered when they are unmasked and passed through the reconstruction model 202. More particularly, in FIG. 2 the reconstruction model 202 reconstructs the first and second reconstructed inputs 206a,b from the first and second masked inputs 204a,b. The encoder network 104 respectively encodes the first and second reconstructed inputs 206a,b into first and second latent representations 208a,b in the latent space 108. The encoder network 104 also encodes the unmasked time series input 112 into its latent representation 110 in the latent space. The error between the latent representation 110 of the unmasked time series input 112 and the first and second latent representations 208a,b generated from the reconstructed inputs 206a,b is indicative of the importance of the features masked in the first and second masked inputs 204a,b, respectively. For example, FIG. 2 shows a greater distance 210b between the second latent reprentation 208b (which corresponds to the second masked input 204b) and the unmasked input's 112 latent representation 110 than a distance 210a between the first latent representation 208a (which coresponds to the first masked input 204a) and the unmasked input's 112 latent representation 110. Consequently, the features masked in the first masked input 204a are more important to the reference model's 102 classification than the second masked input 204b. This conclusion intuitively makes sense in the depicted example as all the features masked in the second masked input 204b are also masked in the first masked input 204a.

The reward function for the MDP, which may be maximized through the selection of actions which recover the highest latent understanding, is now outlined. In at least some embodiments, the recovery of latent understanding can be quantified as the improvement in latent space loss (Loss_{L}) when uncovering a new feature and normalized by the latent loss with fully masked input, expressed as:

$$Reward ( {a}_{i} ) = \frac{{Loss}_{L} ( x , M ( x , {m}_{i} ) ) - {Loss}_{L} ( x , M ( x , {m}_{i + 1} ) )}{{Loss}_{L} ( x , M ( x , {m}_{0} ) )} , \qquad ( 4 )$$

where M(x, mᵢ) represents the reconstruction of the input under mask mᵢ. In this formulation, the reward may be based on a change in distance between latent representations, where the distances are measured relative to the latent representation of the unmasked (true) input. The normalization may help improve convergence of the policy during training, as the scale of Loss_{L}(x, M(x, m₀) can vary across different time-series inputs.

In alternative embodiments, the reward can be defined as a local difference between successive reconstructions, expressed as:

$$Reward ( {a}_{i} ) = MSE ( E [ R ( M ( x , {m}_{i + 1} ) ) ] , E [ R ( M ( x , {m}_{i} ) ) ] ) , \qquad ( 4.1 )$$

where E(·) is the encoder network and R(·) is the reconstruction model. In this case, the reward may be based on a distance in latent space between two successive reconstructed inputs. By considering local differences rather than an absolute distance to the true input, this formulation may preserve conditional dependencies and may assign value to features according to their marginal impact in context. In some instances, this can reduce bias toward features unmasked early in the sequence and can allow features that provide meaningful contributions only in combination with other features to be recognized, which may assist in capturing synergistic relationships among features.

Both formulations (Eq. 4 and Eq. 4.1) may be effective in practice. While these two approaches are described as examples, other comparison strategies may also be employed. For instance, latent-space distances between any two reconstructed inputs, whether successive or non-successive, may be compared; or distances may be measured between a reconstructed input and the latent representation of the unmasked input. More generally, any formulation that defines the reward in terms of differences in latent-space distances between masked or unmasked states may be applied, provided that it yields a measure of feature contribution that is useful for training. Accordingly, the reward signal is not limited to the particular forms illustrated herein, but may encompass alternative definitions that achieve technically similar effects.

Further alternative reward definitions are possible. For example, in some embodiments, the reward signal may be defined as follows:

$${Reward}_{f 1} ( {a}_{i} ) = MSE ( R ( x , {m}_{t + 1} ) , R ( x , {m}_{t} ) ) , \qquad ( 4.2 )$$

$${Reward}_{f 2} ( {a}_{i} ) = MSE ( E ( R ( x , {m}_{t + 1} ) ) , E ( R ( x , {m}_{0} ) ) ) , \qquad ( 4.3 )$$

$${Reward}_{f 3} ( {a}_{i} ) = \frac{MSE ( E ( R ( x , {m}_{t + 1} ) ) , E ( R ( x , 0 ) ) )}{MSE ( E ( R ( x , 1 ) ) , E ( R ( x , 0 ) ) )} . \qquad ( 4.4 )$$

Experimental results comparing these formulations are summarized in Table 1. The “default” formulation corresponds to Eq. 4.1.

| | | Metric | | |
|---|---|---|---|---|
| Dataset | Method | AUPRC | AUP | AUR |
| SeqCombUV | Default | 0.9549 ± 0.0006 | 0.7609 ± 0.0007 | 0.7701 ± 0.0012 |
| | Eq. 4.2 | 0.9199 ± 0.0022 | 0.7150 ± 0.0015 | 0.7189 ± 0.0024 |
| | Eq. 4.3 | 0.8062 ± 0.0028 | 0.6753 ± 0.0022 | 0.5855 ± 0.0027 |
| | Eq. 4.4 | 0.8002 ± 0.0033 | 0.6989 ± 0.0023 | 0.5455 ± 0.0028 |
| SeqCombMV | Default | 0.9137 ± 0.0011 | 0.8514 ± 0.0010 | 0.5937 ± 0.0013 |
| | Eq. 4.2 | 0.8515 ± 0.0040 | 0.6959 ± 0.0018 | 0.6557 ± 0.0037 |
| | Eq. 4.3 | 0.7655 ± 0.0048 | 0.6614 ± 0.0039 | 0.5810 ± 0.0045 |
| | Eq. 4.4 | 0.7633 ± 0.0045 | 0.7760 ± 0.0038 | 0.4408 ± 0.0035 |

These results indicate that while the “default” reward formulation (Eq. 4.1) generally provides more stable performance, alternative definitions such as Eqs. 4.2-4.4 are also workable in practice. The choice of reward definition may therefore be adapted according to the requirements of a particular application, and is not limited to the examples disclosed herein.

### Policy

The C51 algorithm [3] is used to guide the RL policy responsible for selecting which features of the time series data to unmask. C51 is a distributional RL algorithm that approximates the action-value distribution by discretizing it into 51 fixed bins and their corresponding probabilities allowing for detailed representation of the variability in future rewards. This is particularly advantageous in at least some example embodiments where rewards can exhibit significant variability across samples. By using C51's discretization of reward distribution into bins, the reconstruction model 202 can more accurately capture the uncertainty and diversity of potential outcomes associated with each feature selection decision. This leads to more robust feature attribution as the policy can better account for uncertainty in the explanatory power of the feature it selects. Consequently, C51 helps the agent make more nuanced decisions about which features to prioritize, improving the reliability and interpretability of the model explanations. While the C51 algorithm is used in the present example embodiment, in different embodiments different algorithms may be used. For example, the Proximal Policy Optimization (“PPO”) [5] or Deep Q-Learning (“DQN”) [6] algorithm may alternatively be used.

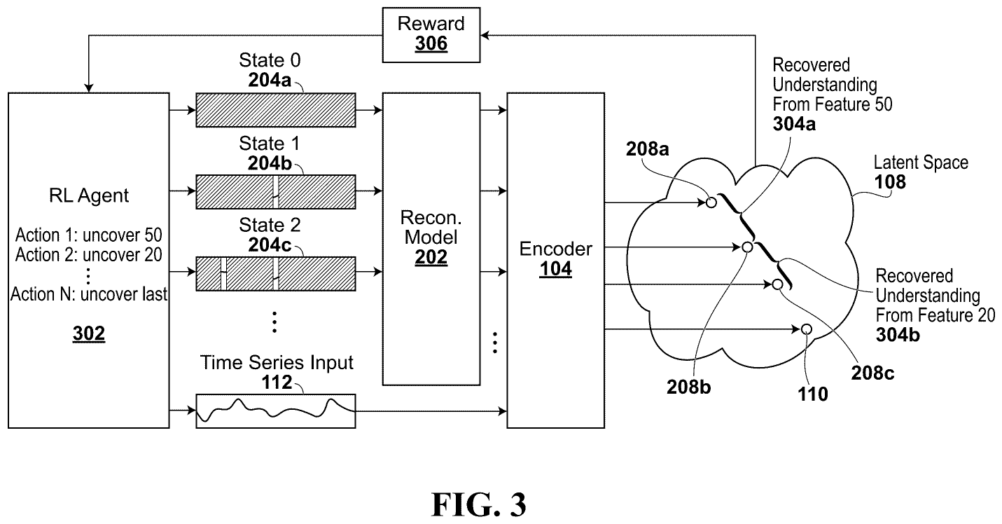

The MDP process for selecting features using the policy is highlighted in FIG. 3. More particularly, FIG. 3 depicts a RL training pipeline in which a RL agent 302 sequentially selects features to unmask from the time series input 112, and how those unmasked features can be used to recover latent understanding. The RL agent 302 is trained to ideally maximally recover latent understanding, and its preferences are used to define feature importance.

In FIG. 3, the RL agent 302 performs first through Nth actions, with each action corresponding to uncovering different features of an entirely masked version of the time series input 112. FIG. 3 depicts the unmasked version of the time series input 112, a first input 204a that is entirely masked (“State 0”); a second input 204b that has one portion thereof unmasked (“State 1”), which results from the RL agent 302 performing Action 1 (“uncover [feature]50”) on the first input 204a; and a third input 204c that has an additional portion thereof unmasked (“State 2”) relative to the second input 204b, and which results from the RL agent 302 performing Action 2 (“uncover [feature]20”) on the second input 204b. The RL agent 302 successively unmasks additional features from the inputs until it performs Action N (“uncover last [feature]”), which removes the last masked feature of the inputs to reveal the entirety of the time series input 112.

Some or all of the inputs, either entirely masked or partially masked, are input to the reconstruction model 202, which generates reconstructed inputs, and those reconstructed inputs are then input to the encoder network 104, together with the time series input 112 as the true input, to generate various latent representations, all as discussed in respect of FIG. 2 above. More particularly, the unmasked version of the time series input 112 corresponds to one of the latent representations 110; the first masked input (State 0) 204a corresponds to the first latent representation 208a; the second masked input (State 1) 204b corresponds to the second latent representation 208b; and the third masked input (State 2) 204c corresponds to the third latent representation 208c. While there are more than three states in this example, only three are shown in FIG. 3 for ease of illustration. The first distance 304a between the first and second latent representations 208a,b accordingly represents the marginal latent understanding relative to a totally masked input recovered when feature 50 is unmasked, while the second distance 304b between the second and third latent reprentations 208b,c accordingly represents the marginal latent understanding gained when transitioning from States 1 to 2. A reward 306 is determined as described above and used to train the RL agent 302. In at least some embodiments, the reward 306 corresponds to the improvement in latent-space loss normalized by the fully masked case, although other loss measures may alternatively be used.

When applying the C51 policy as described above to a given time series instance, x, at each step, t, it provides a distribution over reward values, R(sₜ, i), for unmasking a given feature index i. These decisions of the reinforcement learning agent are referred to as “unmasking decisions”, since each action corresponds to uncovering a feature that was previously masked. Each feature's importance is defined as its expected value under this expected reward distribution at time step 0. The importance scores provide a quantitative measure of how much each feature contributes to the classification decision of the reference model. If a task requires a binary mask for explanations, a threshold, θ, can be identified here for masking:

$${m}_{i} = I [ 𝔼 [ R ( {s}_{0} , i ) ] > θ ] . \qquad ( 5 )$$

where I is the indicator function. This thresholding operation can convert continuous importance scores into a binary attribution mask, which can then be used to generate an explanation output highlighting the specific features of the input time series that contributed to the model's classification decision.

### Example Applications and Technical Benefits

The trained reconstruction model and reinforcement learning agent illustrated in FIGS. 2 and 3 may be employed in a variety of practical applications where accurate and interpretable analysis of time series data is desired. Many real-world systems rely on time series inputs from sensors, monitors, or transaction records, and the ability to determine which features are more relevant to a model's prediction provides a technical improvement over conventional black-box approaches.

In the medical field, for example, electroencephalogram (EEG) data, electrocardiogram (ECG) data, or other physiological signals may be analyzed by a deep learning model to predict the onset of a seizure, cardiac irregularity, or other health condition. When applied in this setting, the attribution masks generated by the reinforcement learning agent identify which temporal segments or sensor channels contribute most strongly to the classification. This allows clinicians to validate the automated result and to associate predictive importance with specific physiological phenomena, thereby integrating machine predictions with established medical reasoning. This particular example provides a technical solution to the problem of interpretability in clinical decision support systems, enhancing both trust and usability in high-stakes healthcare environments.

In industrial monitoring, time series signals from equipment sensors can be used to detect anomalies such as bearing faults, vibration patterns, or abnormal temperature fluctuations. Conventional anomaly detection models may provide a binary decision without indicating why an event was flagged. By contrast, the disclosed approaches provide an attribution mask that highlights the precise sensor readings and time intervals that most influenced the decision, thereby assisting operators in diagnosing the root cause of a failure. This interpretability can reduce downtime and enables targeted maintenance actions, yielding practical benefits in safety and efficiency.

Financial forecasting presents another context in which the disclosed approaches may be applied. Time series data such as transaction volumes, market indices, or customer activity logs can be processed by predictive models for fraud detection or portfolio risk assessment. Attribution masks produced according to the disclosed approaches can identify which temporal features or account behaviors most strongly affect the model's predictions, enabling auditors or analysts to evaluate the basis of the prediction. This improves compliance with regulatory requirements that demand explainability in automated decision systems, and provides actionable insight beyond a raw prediction score.

From a technical perspective, the training of the reconstruction model using latent-space, input-space, and/or classification-space losses helps the reconstructed inputs faithfully recover the underlying structure of the time series input. The reinforcement learning agent, in turn, is trained to unmask features that maximize this recovery, producing attribution masks that are not only interpretable but also quantitatively grounded in the behavior of the reference model. This combination results in improved performance across diverse domains, since the same training framework adapts to different types of time series data while providing feature-level explanations that were previously unavailable.

The disclosed approaches therefore provide a technical improvement in practical applications where time series data analysis is desired. The ability to attribute model predictions to specific temporal features directly addresses the black-box behaviour of the existing solutions, offering both predictive accuracy and descriptive insight in various fields, such as safety-critical, industrial, and financial applications.

### Experiments

In this section, the quality of explanations on four synthetic datasets and six real-world datasets is evaluated. All reported results for our method and baselines are presented as mean±std from 5 fold cross-validation ran across 5 seeds.

In the experiments, synthetic datasets FreqShapes [1] and real-world dataset Epilepsy [4]. The synthetic datasets were designed by TimeX [1] to encapsulate a wide array of temporal dynamics within both univariate and multivariate settings. The Epilepsy dataset contains identification of electroencephalogram seizure episodes.

For FreqShapes, predictive signal was determined by the frequency of occurrence of an anomaly signal. To construct the dataset, two upward and downward spike shapes and two frequencies, 10 and 17 time steps, were used. There were four classes, each with a different combination of the attributes: class 0 had a downward spike occurring every 10-time steps, class 1 had an upward spike occurring every 10-time steps, class 2 had a downward spike occurring every 17-time steps, and class 3 had an upward spike occurring every 17-time steps. Ground-truth explanations were the locations of the upward and downward spikes.

An example embodiment of the method was evaluated against the most recent baselines, TimeX [1] and TimeX++[2].

For synthetic datasets, given that the precise salient features were known, they were utilized as the ground truth for evaluating explanations. These were known predictive signals in each input time series sample when interpreting a strong predictor. Following [1, 2], the quality of explanations was evaluated with Area Under Precision (“AUP”) and Area Under Recall (“AUR”) curves. Area Under the Precision-Recall Curve (“AUPRC”), which combines the results of AUP and AUR, was also used.

More particularly, in respect of computing AUP, AUR, and AUPRC, let q_{t,i} be the indicator variables for the true salient features and \hat{q}_{t,i} be mask for the predicted ones, with t ranging over time and i ranging over indices for multivariate features at each timestep. Also, define the sets A={q_{t,i}}_{t,i} and Â(τ)={q_{t,i}}_{t,i}. The explainer model assigns a saliency score in (0,1) to every input feature indicating how important it is. Then, a mask is generated by thresholding the saliency score at τ. The precision is then defined as

$$P ( τ ) = \frac{\vert A ⋂ \hat{A} ( τ ) \vert}{\vert \hat{A} ( τ ) \vert} ,$$

and recall is defined as as

$$R ( τ ) = \frac{\vert A ⋂ \hat{A} ( τ ) \vert}{\vert A \vert} .$$

Then AUP and AUR can be obtained by (approximately) integrating τ from 0 to 1.

For real world datasets, ground truth labels for evaluating explanations were not available and so in following with TimeX the bottom p percentile of features as identified by the explainer were occluded and the change in prediction Area Under the Receiver Operating Characteristic (AUROC) was measured. The most essential features a strong explainer identifies should retain prediction performance under occlusion when p is high for all metrics. With higher values being better, results were averaged over 5 random seed runs, and averaged across 5 data splits.

Performance on synthetic datasets including FreqShape, SeqCombUV, and SeqCombMV was summarized in Table 2. As shown, the disclosed approach of the example embodiment consistently achieved higher AUPRC, AUP, and AUR scores compared to the baselines. In particular, the disclosed approach of the example embodiment attained outstanding agreement with the ground-truth salient features on FreqShape (AUPRC=1.0000, AUP=0.9207, AUR=0.9865), while also ranking favourably across the multivariate tasks. These results confirmed that the reinforcement learning-guided masking framework produced explanations that better aligned with known predictive signals than prior methods.

TABLE 2
Performance on FreqShape

| | | Metric | | | Sum. |
|---|---|---|---|---|---|
| Dataset | Method | AUPRC | AUP | AUR | Rank |
| FreqShape | IG | 0.7516 ± 0.0032(4) | 0.6912 ± 0.0028(4) | 0.5975 ± 0.0020(4) | 12 |
| | DynaMask | 0.2201 ± 0.0013(5) | 0.2952 ± 0.0037(5) | 0.5037 ± 0.0015(5) | 15 |
| | TimeX | 0.8324 ± 0.0034(3) | 0.7912 ± 0.0013(3) | 0.6381 ± 0.0022(3) | 9 |
| | TimeX++ | 0.8905 ± 0.0018(2) | 0.7805 ± 0.0042(4) | 0.6618 ± 0.0019(2) | 6 |
| | Example | 1.0000 ± 0.0000(1) | 0.9207 ± 0.0007(1) | 0.9865 ± 0.0002(1) | 3 |
| | Embodiment | | | | |
| SeqCombUV | IG | 0.5760 ± 0.0022(4) | 0.8157 ± 0.0023(4) | 0.2868 ± 0.0023(4) | 12 |
| | DynaMask | 0.4421 ± 0.0016(5) | 0.8782 ± 0.0039(3) | 0.1029 ± 0.0077(5) | 13 |
| | TimeX | 0.7124 ± 0.0017(3) | 0.9411 ± 0.0006(1) | 0.3380 ± 0.0014(3) | 7 |
| | TimeX++ | 0.8468 ± 0.0004(2) | 0.9696 ± 0.0003(1) | 0.4064 ± 0.0011(2) | 6 |
| | Example | 0.9549 ± 0.0006(1) | 0.7609 ± 0.0007(5) | 0.7701 ± 0.0012(1) | 7 |
| | Embodiment | | | | |
| SeqCombMV | IG | 0.3298 ± 0.0015(4) | 0.7483 ± 0.0027(4) | 0.2581 ± 0.0028(4) | 12 |
| | DynaMask | 0.3136 ± 0.0019(5) | 0.5481 ± 0.0035(5) | 0.1953 ± 0.0025(5) | 15 |
| | TimeX | 0.6878 ± 0.0021(3) | 0.8326 ± 0.0009(3) | 0.3872 ± 0.0016(3) | 9 |
| | TimeX++ | 0.7589 ± 0.0014(2) | 0.8783 ± 0.0007(1) | 0.3906 ± 0.0010(2) | 5 |
| | Example | 0.9137 ± 0.0011(1) | 0.8514 ± 0.0010(2) | 0.5937 ± 0.0013(1) | 4 |
| | Embodiment | | | | |

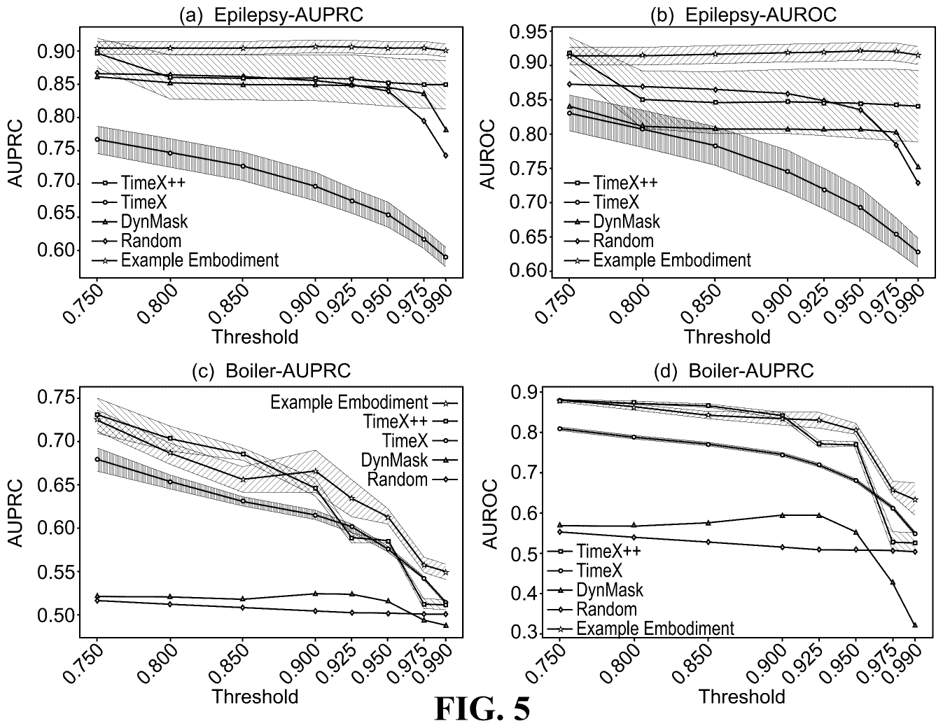

Occlusion experiments were further conducted to evaluate explanation quality on real-world datasets such as Epilepsy and Boiler. Results were depicted in FIG. 5, which showed AUPRC and AUROC scores under progressively stricter occlusion thresholds. The disclosed approach of the example embodiment maintained higher prediction performance across thresholds compared to TimeX, TimeX++, and DynaMask. For example, in the Epilepsy dataset (charts (a) and (b) in FIG. 5), the explanations enabled models to retain AUROC close to baseline performance. Similarly, in the Boiler dataset (charts (c) and (d) in FIG. 5), the disclosed approach demonstrated better stability under occlusion, indicating that its attribution masks more reliably captured the features most relevant to model predictions.

In view of the above, it has been demonstrated that the disclosed approach not only improved explanation quality on synthetic datasets with known ground truth but also yielded interpretable and stable attributions in real-world applications. This validated the technical advantages of combining masked reconstruction with reinforcement learning in producing attribution masks for time series data.

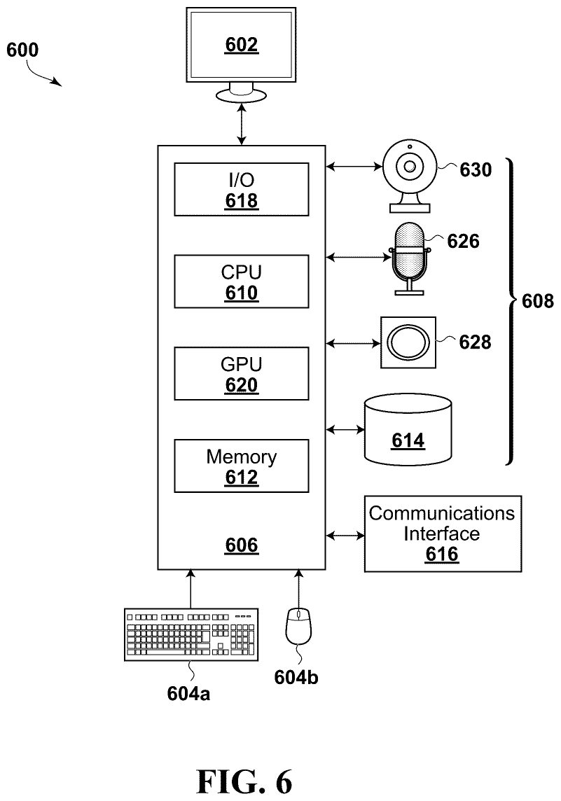

An example computer system in respect of which the methodology described above may be implemented is presented as a block diagram in FIG. 6. The example computer system is denoted generally by reference numeral 600 and includes a display 602, input devices in the form of keyboard 604a and pointing device 604b, computer 606 and external devices 608. While pointing device 604b is depicted as a mouse, it will be appreciated that other types of pointing device, or a touch screen, may also be used.

The computer 606 may contain one or more processors or microprocessors, such as a central processing unit (CPU) 610. The CPU 610 performs arithmetic calculations and control functions to execute software stored in a non-transitory internal memory 612, preferably random access memory (RAM) and/or read only memory (ROM), and possibly storage 614. The storage 614 is non-transitory may include, for example, mass memory storage, hard disk drives, optical disk drives (including CD and DVD drives), magnetic disk drives, magnetic tape drives (including LTO, DLT, DAT and DCC), flash drives, program cartridges and cartridge interfaces such as those found in video game devices, removable memory chips such as EPROM or PROM, emerging storage media, such as holographic storage, or similar storage media as known in the art. This storage 614 may be physically internal to the computer 606, or external as shown in FIG. 6, or both. The storage 614 may also comprise a database for storing images and data generated as a result of performing OCR on those images, as described above.

The one or more processors or microprocessors are examples of suitable processing units. Additionally or alternatively, a suitable processing unit may comprise any one or more of an artificial intelligence accelerator, programmable logic controller, a microcontroller (which comprises both a processing unit and a non-transitory computer readable medium), AI accelerator, or system-on-a-chip (SoC). As an alternative to an implementation that relies on processor-executed computer program code, a hardware-based implementation may be used. For example, other types of processing units such as an application-specific integrated circuit (ASIC), field programmable gate array (FPGA), or other suitable type of hardware implementation may be used as an alternative to or to supplement an implementation that relies primarily on a processor executing computer program code stored on a computer medium.

Any one or more of the methods described above may be implemented as computer program code and stored in the internal memory 612 and/or storage 614 for execution by the one or more processors or microprocessors to effect neural network pre-training, training, or use of a trained network for inference.

The computer system 600 may also include other similar means for allowing computer programs or other instructions to be loaded. Such means can include, for example, a communications interface 616 which allows software and data to be transferred between the computer system 600 and external systems and networks. Examples of communications interface 616 can include a modem, a network interface such as an Ethernet card, a wireless communication interface, or a serial or parallel communications port. Software and data transferred via communications interface 616 are in the form of signals which can be electronic, acoustic, electromagnetic, optical or other signals capable of being received by communications interface 616. Multiple interfaces, of course, can be provided on a single computer system 600.

Input and output to and from the computer 606 is administered by the input/output (I/O) interface 618. This I/O interface 618 administers control of the display 602, keyboard 604a, external devices 608 and other such components of the computer system 600. The computer 606 also includes a graphical processing unit (GPU) 620. The latter may also be used for computational purposes as an adjunct to, or instead of, the CPU 610, for mathematical calculations.

The external devices 608 include a microphone 626, a speaker 628 and a camera 630. Although shown as external devices, they may alternatively be built in as part of the hardware of the computer system 600.

The various components of the computer system 600 are coupled to one another either directly or by coupling to suitable buses.

The term “computer system”, “data processing system” and related terms, as used herein, is not limited to any particular type of computer system and encompasses servers, desktop computers, laptop computers, networked mobile wireless telecommunication computing devices such as smartphones, tablet computers, as well as other types of computer systems.

The embodiments have been described above with reference to flow, sequence, and block diagrams of methods, apparatuses, systems, and computer program products. In this regard, the depicted flow, sequence, and block diagrams illustrate the architecture, functionality, and operation of implementations of various embodiments. For instance, each block of the flow and block diagrams and operation in the sequence diagrams may represent a module, segment, or portion of code, which comprises one or more executable instructions for implementing the specified action(s). In some alternative embodiments, the action(s) noted in that block or operation may occur out of the order noted in those figures. For example, two blocks or operations shown in succession may, in some embodiments, be executed substantially concurrently, or the blocks or operations may sometimes be executed in the reverse order, depending upon the functionality involved. Some specific examples of the foregoing have been noted above but those noted examples are not necessarily the only examples. Each block of the flow and block diagrams and operation of the sequence diagrams, and combinations of those blocks and operations, may be implemented by special purpose hardware-based systems that perform the specified functions or acts, or combinations of special purpose hardware and computer instructions.

The terminology used herein is for the purpose of describing particular embodiments only and is not intended to be limiting. Accordingly, as used herein, the singular forms “a”, “an”, and “the” are intended to include the plural forms as well, unless the context clearly indicates otherwise. It will be further understood that the terms “comprises” and “comprising”, when used in this specification, specify the presence of one or more stated features, integers, steps, operations, elements, and components, but do not preclude the presence or addition of one or more other features, integers, steps, operations, elements, components, and groups. Directional terms such as “top”, “bottom”, “upwards”, “downwards”, “vertically”, and “laterally” are used in the following description for the purpose of providing relative reference only, and are not intended to suggest any limitations on how any article is to be positioned during use, or to be mounted in an assembly or relative to an environment. Additionally, the term “connect” and variants of it such as “connected”, “connects”, and “connecting” as used in this description are intended to include indirect and direct connections unless otherwise indicated. For example, if a first device is connected to a second device, that coupling may be through a direct connection or through an indirect connection via other devices and connections. Similarly, if the first device is communicatively connected to the second device, communication may be through a direct connection or through an indirect connection via other devices and connections.

Use of language such as “at least one of X, Y, and Z,” “at least one of X, Y, or Z,” “at least one or more of X, Y, and Z,” “at least one or more of X, Y, and/or Z,” or “at least one of X, Y, and/or Z,” is intended to be inclusive of both a single item (e.g., just X, or just Y, or just Z) and multiple items (e.g., {X and Y}, {X and Z}, {Y and Z}, or {X, Y, and Z}). The phrase “at least one of” and similar phrases are not intended to convey a requirement that each possible item must be present, although each possible item may be present.

It is contemplated that any part of any aspect or embodiment discussed in this specification can be implemented or combined with any part of any other aspect or embodiment discussed in this specification, so long as such those parts are not mutually exclusive with each other.

The scope of the claims should not be limited by the embodiments set forth in the above examples, but should be given the broadest interpretation consistent with the description as a whole.

It should be recognized that features and aspects of the various examples provided above can be combined into further examples that also fall within the scope of the present disclosure. In addition, the figures are not to scale and may have size and shape exaggerated for illustrative purposes.

### REFERENCES

[1] Owen Queen, Tom Hartvigsen, Teddy Koker, Huan He, Theodoros Tsiligkaridis, and Marinka Zitnik. Encoding time-series explanations through self-supervised model behavior consistency. Advances in Neural Information Processing Systems, 36, 2024.
[2] Zichuan Liu, Tianchun Wang, Jimeng Shi, Xu Zheng, Zhuomin Chen, Lei Song, Wenqian Dong, Jayantha Obeysekera, Farhad Shirani, and Dongsheng Luo. Timex++: Learning time-series explanations with information bottleneck. arXiv preprint arXiv:2405.09308, 2024.
[3] Marc G Bellemare, Will Dabney, and Rémi Munos. A distributional perspective on reinforcement learning. In International conference on machine learning, pp. 449-458. PMLR, 2017.
[4] Ralph G Andrzejak, Klaus Lehnertz, Florian Mormann, Christoph Rieke, Peter David, and Christian E Elger. Indications of nonlinear deterministic and finite-dimensional structures in time series of brain electrical activity: Dependence on recording region and brain state. Physical Review E, 64(6):061907, 2001.
[5] John Schulman, Filip Wolski, Prafulla Dhariwal, Alec Radford, Oleg Klimov. Proximal Policy Optimization Algorithms. arXiv:1707.06347[cs.LG], 2017.
[6] Volodymyr Mnih, Koray Kavukcuoglu, David Silver, Alex Graves, Ioannis Antonoglou, Daan Wierstra, Martin Riedmiller. Playing Atari with Deep Reinforcement Learning. arXiv:1312.5602 [cs.LG], 2013.

1. A method for training a reconstruction model, the method comprising:
(a) respectively reconstructing, using the reconstruction model, a plurality of reconstructed inputs from the plurality of masked inputs, wherein each of the masked inputs is a differently masked version of a time series input, and each of the plurality of reconstructed inputs is unmasked version of the time series input in a data domain;
(b) encoding, using an encoder network, the time series input and the plurality of reconstructed inputs into respective latent representations in a latent space; and
(c) training the reconstruction model based at least in part on a latent-space loss determined from differences between the latent representation of the time series input and the respective latent representations of the reconstructed inputs.

2. The method of claim 1, further comprising generating the plurality of masked inputs from the time series input.

3. The method of claim 1, further comprising determining, using a decoder network, respective classifications from the time series input and the plurality of reconstructed inputs, wherein training the reconstruction model further comprises reducing a classification loss.

4. The method of claim 3, wherein the classification loss is determined from differences between the classification of the time series input and the respective classifications of the reconstructed inputs.

5. The method of claim 3, wherein the classification loss is determined from differences between prediction probabilities output by the decoder network for the time series input and the prediction probabilities output by the decoder network for the respective reconstructed inputs.

6. The method of claim 1, wherein training the reconstruction model further comprises reducing an input-domain loss determined from differences between the time series input and the respective reconstructed inputs.

7. The method of claim 3, wherein training the reconstruction model further comprises reducing an input-domain loss determined from differences between the time series input and the respective reconstructed inputs, and wherein training the reconstruction model further comprises reducing a combined loss defined as a sum of the latent-space loss, the classification loss, and the input-domain loss respectively weighted according to a plurality of hyperparameters.

8. The method of claim 1, wherein the plurality of masked inputs are sequentially indexed such that any one of the masked inputs comprises all masks from any prior indexed ones of the masked inputs and has at least one additional portion thereof masked.

9. The method of claim 1, wherein the reconstruction model is a heteroscedastic model configured to output mean and variance values for features of the time series input.

10. The method of claim 1, wherein generating the plurality of masked inputs comprises masking features according to a sequential order, a random selection, or a contiguous temporal span.

11. A method for training a reinforcement learning agent, the method comprising:
(a) successively unmasking, using the reinforcement learning agent, portions of a masked version of a time series input to generate a plurality of masked inputs;
(b) respectively reconstructing, by a reconstruction model, a plurality of reconstructed inputs from the plurality of masked inputs using the reconstruction model having been trained to reduce a latent-space loss determined from differences between a latent representation of the time series input and the latent representations of reconstructed inputs;
(c) encoding, using an encoder network, the reconstructed inputs and an unmasked version of the time series input as respective latent representations in a latent space; and
(d) training the reinforcement learning agent based at least in part on a reward signal derived from differences in the latent-space loss between a plurality of the latent representations.

12. The method of claim 11, wherein the masked version of the time series input is initially entirely masked, and wherein the unmasked version of the time series input is entirely unmasked.

13. The method of claim 11, wherein the unmasking is performed in accordance with a Categorical 51 (C51) algorithm, a Proximal Policy Optimization (PPO) algorithm, or a Deep Q-Learning (DQN) algorithm.

14. The method of claim 11, wherein the reward signal is further defined as a normalized improvement in the latent-space loss, the normalization being based on the latent-space loss determined from the masked version of the time series input that is entirely masked.

15. The method of claim 11, further comprising generating an attribution mask for the time series input based on unmasking decisions of the reinforcement learning agent.

16. The method of claim 15, wherein generating the attribution mask comprises assigning an importance score to each feature of the time series input based on an expected reward distribution produced by the reinforcement learning agent, and applying a threshold to the importance scores to produce a binary mask.

17. The method of claim 15, wherein the attribution mask is used to generate an explanation output that identifies one or more features of the time series input contributing to a classification decision obtained from the time series input.

18. The method of claim 11, wherein the reconstruction model is trained by:
(a) respectively reconstructing, using the reconstruction model, a plurality of historical reconstructed inputs from the plurality of historical masked inputs, wherein each of the historical masked inputs is a differently masked version of a historical time series input, and each of the plurality of historical reconstructed inputs is an unmasked version of the historical time series input in a data domain;
(b) encoding, using the encoder network, the historical time series input and the plurality of historical reconstructed inputs into respective latent representations in the latent space; and
(c) training the reconstruction model based at least in part on a historical latent-space loss determined from differences between the latent representation of the historical time series input and the respective latent representations of the historical reconstructed inputs.

19. The method of claim 11, wherein the training of the reinforcement learning agent is formulated as a Markov Decision Process (MDP) defined by:
(a) a state space comprising pairs of a time series input and a binary mask indicating masked and unmasked features;
(b) an action space comprising indices of features corresponding to masked positions in the binary mask; and
(c) a dynamics model that transitions the binary mask by unmasking a selected feature index according to the action.

20. The method of claim 11, wherein the reward signal is derived from the differences in the latent-space loss between the latent representation of the unmasked version of the time series input and the latent representations of the reconstructed inputs, or from the differences in the latent-space loss between the latent representations of successive reconstructed inputs obtained from the plurality of masked inputs.

21. A system for processing time series data, the system comprising:
a reconstruction model configured to receive a plurality of plurality of masked inputs and reconstruct a plurality of reconstructed inputs from the plurality of masked inputs, wherein each of the masked inputs is a differently masked version of a time series input, and each of the plurality of reconstructed inputs is unmasked version of the time series input in a data domain;
an encoder network configured to encode the time series input and the plurality of reconstructed inputs into respective latent representations in a latent space; and
at least one processing unit configured to train the reconstruction model based at least in part on a latent-space loss determined from differences between the latent representation of the time series input and the respective latent representations of the reconstructed inputs.
